(19) United States
(12) Patent Application Publication
(10) Pub. No.: US 2013/0026187 A1
(43) Pub. Date: Jan. 31, 2013

(54) COSMETIC CONTAINER

(71) Applicant: Yu-Seob Kim, Incheon (KR)

(72) Inventor: Yu-Seob Kim, Incheon (KR)

(73) Assignee: YONWOO CO., LTD., Incheon (KR)

(21) Appl. No.: 13/361,921

(22) Filed: Jan. 30, 2012

Related U.S. Application Data
(63) Continuation of application No. PCT/KR2010/003248, filed on May 24, 2010.

(30) Foreign Application Priority Data
Jul. 29, 2009 (KR) 10-2009-0069329

(51) Int. Cl. B65D 83/00; B67D 7/06; B67D 7/84

(52) U.S. Cl. 222/153.13; 222/162; 222/182

(57) ABSTRACT

Disclosed is a cosmetic container which comprises an inner container having a storing part storing a cosmetic, and a pumping part which relatively slides in a certain pumping direction (X-axis direction) and the storing part, thus discharging a cosmetic of the storing part to the outside; a pair of outer caps which are disposed opposite to each other about the inner container in a vertical, horizontal direction (Z-axis direction) of the pumping direction; and a conversion part which is disposed between the inner container and the outer cap and converts a relative approach movement of the pair of the outer caps into a relative slide movement of the storing part and the pumping part.

### TECHNICAL FIELD

The present invention relates to a cosmetic container, and in particular to a cosmetic container which improves an outer appearance as compared to a conventional cosmetic container by changing a pumping structure.

### BACKGROUND ART

A pumping type cosmetic container has a pumping member disposed at an upper side of a body storing content, so the content can be discharged to the outside as the pumping member pumps.

The conventional pumping type cosmetic container comprises a body storing content therein, a discharge part secured to an upper side of the body and storing content, a pumping member secured between the body and the discharge part, thus discharging the content to the outside, and a protection cap protecting the pumping member from being randomly pressurized.

The conventional pumping type cosmetic containers have same designs due to the pumping method, structure and construction, so they fails to satisfy various demands of customers who want various and stylish designs.

### Disclosure of Invention

Accordingly, the present invention overcomes the above-described problems and it is an object of the present invention to provide a cosmetic container which improves an outer appearance as compared to a conventional cosmetic container by changing a pumping structure.

To achieve the above objects, there is provided a cosmetic container, comprising an inner container having a storing part storing a cosmetic, and a pumping part which relatively slides in a certain pumping direction (X-axis direction) and the storing part, thus discharging a cosmetic of the storing part to the outside; a pair of outer caps which are disposed opposite to each other about the inner container in a vertical, horizontal direction (Z-axis direction) of the pumping direction; and a conversion part which is disposed between the inner container and the outer cap and converts a relative approach movement of the pair of the outer caps into a relative slide movement of the storing part and the pumping part.

The conversion part comprises a slider protruded from the storing part; and a guide member which has a guide groove accommodating the slider and moving the slider in a pumping direction depending on a relative approach movement of the outer cap.

The storing part comprises a storing part body having an opening, and a storing part head part formed at an opening of the storing part body, and the sliders are protruded in a pair opposite to each other in a horizontal direction (Y-axis direction) from the string part head.

The guide groove is formed in a longitudinal hole shape with a certain slope.

There is further provided a head guide protrusion which is protruded from the storing part head in a vertical, horizontal direction (Z-axis direction) of the pumping direction.

A head protrusion guide groove is formed at an inner surface of the outer cap in a pumping direction (X-axis direction) as the storing part slides, thus guiding the movement of the head guide protrusion.

The head protrusion guide groove comprises a first head protrusion guide groove guiding a head guide protrusion in a pumping direction (X-axis direction) depending on the slide movement of the storing part; and a second head protrusion guide groove which is bent and extended from the first head protrusion guide groove and guides the head guide protrusion in a rotation direction depending of the rotation of the storing part.

The pumping part comprises a pumping head having a cosmetic discharge port; a pumping hose connecting the cosmetic discharge port from the interior of the storing part; and an elastic member disposed between the pumping head and the storing part head, thus providing an elastic force in a direction spacing apart from each other.

There is further provided a ring shaped intermediate cap which has a through hole through which the cosmetic discharge portion passes, and covers between the pair of the outer caps.

There is further provided an inner cap disposed between the outer cap and the inner container.

The conversion part is disposed at the inner cap.

There is further provided a locking part which is protrude and concaved at the portions corresponding to the inner cap and the outer cap which are dislocated depending on a relative rotation of the inner cap and the outer cap, thus prohibiting a relative approach movement of the pair of the outer caps.

### ADVANTAGEOUS EFFECTS

As described above, the present invention improves an outer appearance as compared to a conventional cosmetic container by changing a pumping structure.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating an outer appearance of a cosmetic container according to a preferred embodiment of the present invention;

FIG. 2 is a plane disassembled perspective view illustrating a cosmetic container according to a preferred embodiment of the present invention;

FIG. 3 is a bottom disassembled perspective view illustrating a cosmetic container according to a preferred embodiment of the present invention;

FIGS. 4 and 5 are cross sectional views illustrating a pumping operation of a cosmetic container according to a preferred embodiment of the present invention;

FIGS. 6 and 7 are perspective views illustrating an operation state of a locking part of a cosmetic container according to a preferred embodiment of the present invention; and

FIGS. 8 and 9 are bottom views illustrating a locking operation based on a movement state of a head guide protrusion of a cosmetic container according to a preferred embodiment of the present invention.

### BEST MODES FOR CARRYING OUT THE INVENTION

The preferred embodiments of the present invention will be described with reference to the accompanying drawings to the extent that those who skilled in the art can easily implement. The present invention can be implemented in various forms, and the disclosed embodiments are not limited thereto. For clarifying the embodiments of the present invention, the elements not related to the subject matters of the present invention will be omitted, and the same elements are given the same reference numerals. The X-, Y-, Z-axes in the present invention does not mean the absolute values, but mean relative directions.

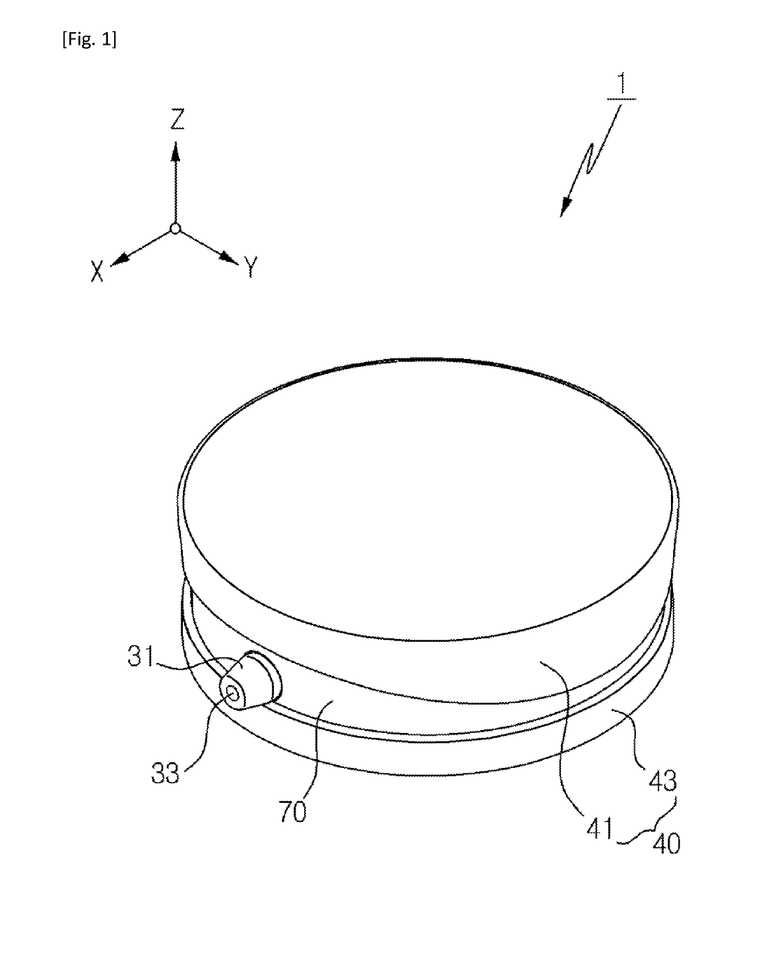

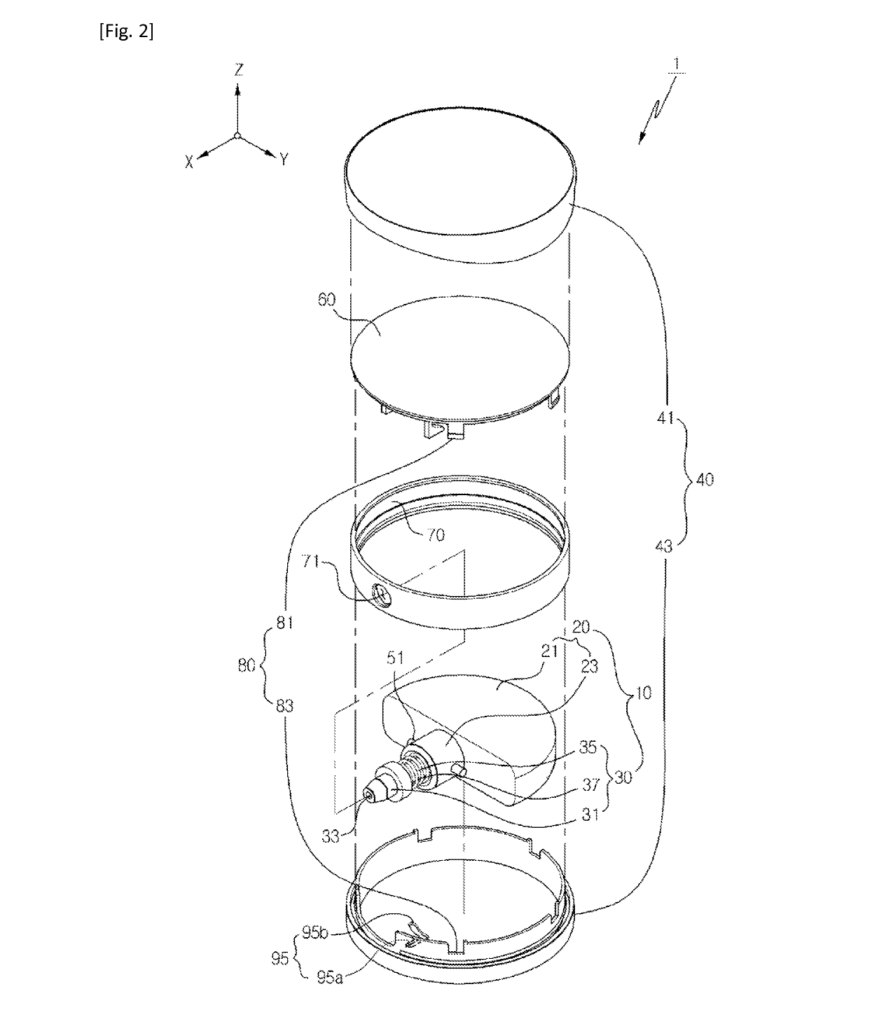

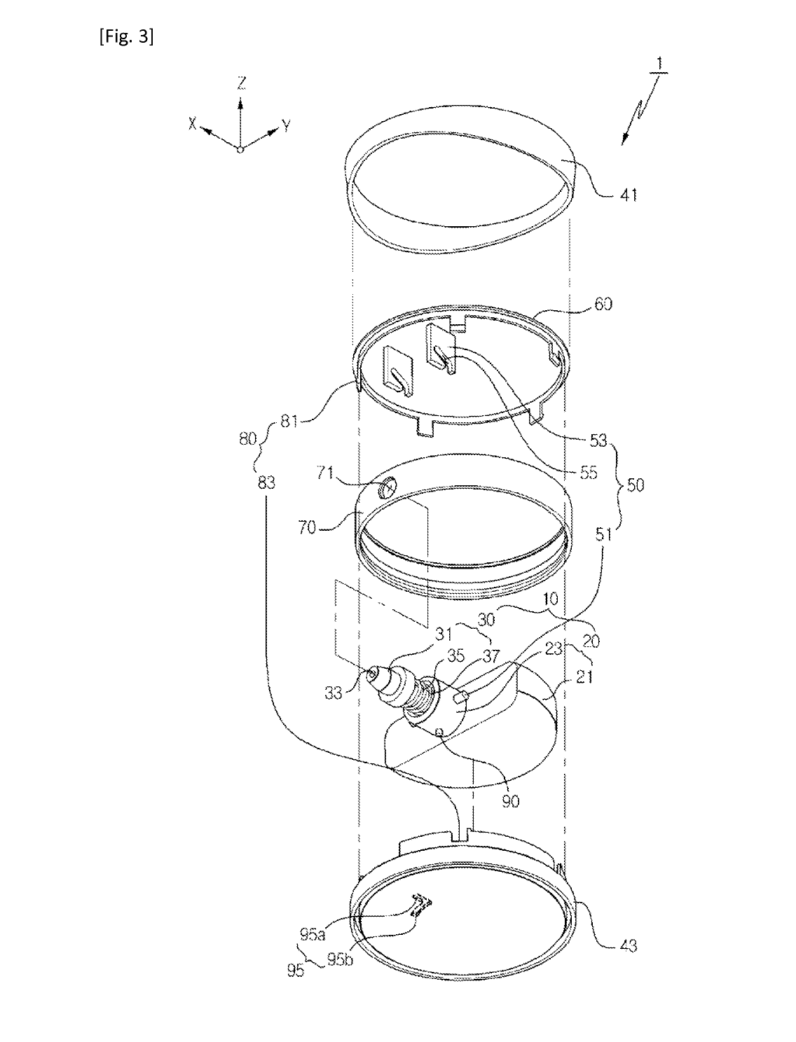

FIG. 1 is a perspective view illustrating an outer appearance of a cosmetic container 1 according to a preferred embodiment of the present invention, and FIG. 2 is a plane disassembled perspective view illustrating a cosmetic container 1 according to a preferred embodiment of the present invention, and FIG. 3 is a bottom disassembled perspective view illustrating a cosmetic container according to a preferred embodiment of the present invention.

As shown in FIGS. 1 through 3, the cosmetic container 1 according to a preferred embodiment of the present invention comprises an inner container 10, a pair of outer caps 40 and a conversion part 50.

The inner container 10 comprises a storing part 20 storing cosmetic, a pumping part 40 which relatively moves in a certain pumping direction (X-axis direction, forward and backward directions and discharges the cosmetics of the storing part 20 to the outside.

The storing part 20 comprises a storing pat body 21 having an opening, and a head part 23 formed at the opening of the storing pat body 21. In the embodiment of the present invention, the storing part body 21 has a flat shaped structure, but its shape is not limited thereto.

The pumping part 30 comprises a pumping head 31 with a cosmetic discharge port 33, a pumping hose 35 connecting the cosmetic discharge port 33 from the interior of the storing part 20, and an elastic member 37 disposed between the pumping hose 35 and the pumping head 31 so as to provide an elastic force in a direction that they are moved in opposite directions.

Since the detailed construction of the pumping part 30 and the procedure that the cosmetic is discharged from the storing part 20 to the outside based on the operation of the pumping part 30 are known to those who skilled in the art, the detailed descriptions thereon will be omitted.

The external caps 40 are provided in a pair about the inner container 10 in the vertical and horizontal opposite directions (Z-axis direction, upper and lower directions) of the pumping direction. The outer cap 4 comprises an upper, outer side cap 41 disposed at an upper side of the inner container 10, and a lower, outer cap 43 disposed at the lower side. The upper, outer cap 41 and the lower, outer cap 43 are formed in cylindrical shapes and have opposite openings, and accommodate the inner container 10 between the same.

The conversion part 50 is disposed between the inner container 10 and the outer container 40 and converts the relative approach movements of the pair of the outer caps 40 into a relative slide movement of the storing part 20 and the pumping part 30. Here, the conversion part 50 comprises a slider 51 protruded from the storing part 20, and a guide member 53 which accommodates the slider 51 and has a guide groove 55 moving the slider 51 in a pumping direction based on a relative approach movement of the pair of the outer caps 40.

It is preferred that the slides 51 are provided in a pair and opposite to each other in the horizontal direction (Y-axis direction, left and right directions) of the pumping direction from the storing part head 23.

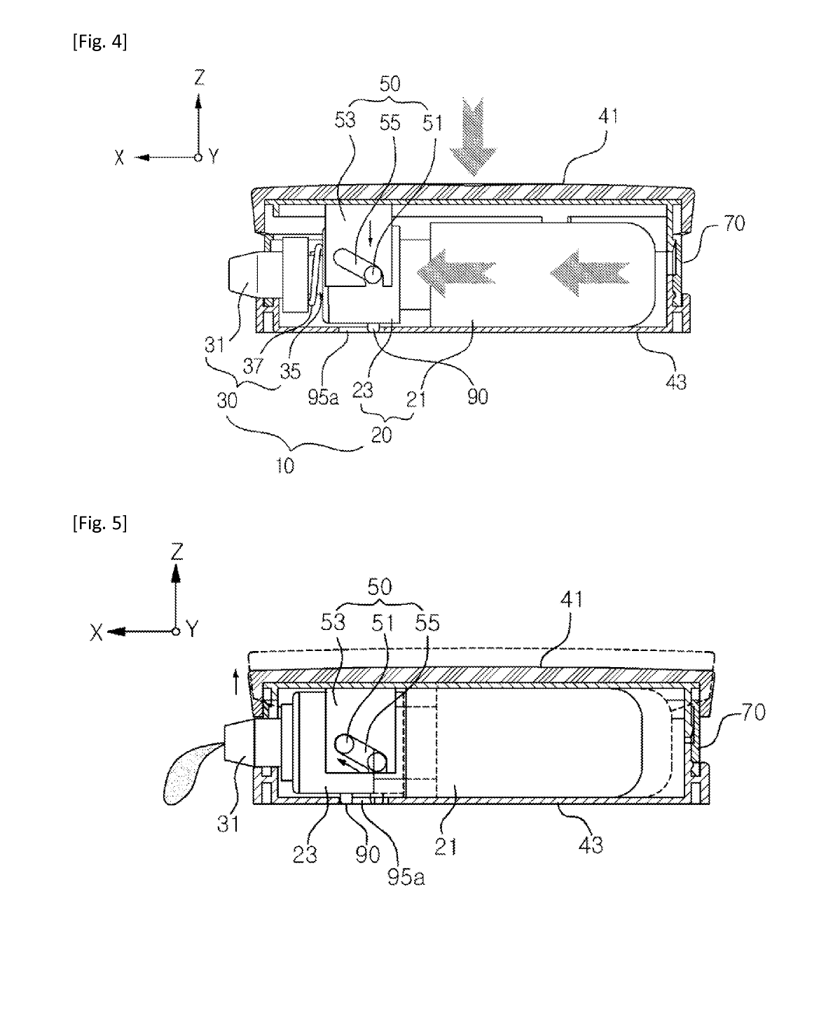

It is preferred that the guide groove 55 is formed in an longitudinal hole shape having a certain slope. As shown in FIGS. 4 and 5, the guide groove 55 is arranged on a X-Y plane with a slope. It is preferred that the guide groove 55 has a slope angle of 30 through 60°, so it is possible to move the slider 5 in a pumping direction without having a phase difference as the pair of the outer caps 40 relatively approach.

In the preferred embodiments of the present invention, it was described that the guide member 53 is disposed between the upper, outer cap 41 and the inner container 10, but it is not limited thereto. It might be disposed between the lower, outer cap 43 and the inner container 10. Alternatively, the guide member 53 can be disposed between the upper, outer cap 41 and the inner container 10, and the lower, outer cap 43 and the inner container 10.

In the preferred embodiments of the present invention, there might be further provided an inner cap 60 disposed between the outer cap 40 and the inner container 10. In the preferred embodiment of the present invention, the guide member 53 is formed integrally with the inner cap 60. Alternatively, the guide member 53 and the inner cap 60 might be separately provided.

In the preferred embodiments of the present invention, there is shown in the drawings that the inner cap 60 is disposed between the upper, outer cap 41 and the inner container 10, but it is not limited thereto. Alternatively, it might be disposed between the lower, outer cap 43 and the inner container 10. The inner cap 60 might be disposed between the upper, outer cap 41 and the inner container 10 and the lower, outer cap 43 and the inner container 10.

In the preferred embodiment of the present invention, the cosmetic container 1 has a through hole 71 through which the cosmetic disport port 33 of the pumping head 31 passes, and a ring-shaped intermediate cap 70 covering a pair of outer caps 40. The intermediate cap 70 prevents the structure between the pair of the outer caps 40 to be exposed to the outside, thus making the construction look better.

The cosmetic container 1 according to the present invention further comprises a locking part 80 having convex and concave portions at the portions matching with the inner cap 60 and the outer cap 40, which convex and concave portions are dislocated by means of the relative rotation of the inner cap 60 and the outer cap 40, thus preventing a relative approach movement of the pair of the outer caps 40.

The locking part 80 comprises a locking protrusion 81 protruded, in a vertical, horizontal direction (Z-axis direction) of the pumping direction, from the inner cap 60, and a locking protrusion guide groove 83 formed at an inner surface of the lower, outer cap 43 and accommodating the locking protrusion 81 depending on a relative approach movement of the pair of the outer caps 40, thus guiding the movement of the same.

The locking protrusion 81 and the locking protrusion guide groove 83 dislocate their positions by means of the relative rotation f the inner cap 60 and the outer cap 40, thus preventing the relative approach movement of the pair of the outer caps 40. Without an additional protection cap (not shown) as in the conventional art, it is possible to prevent the inner container 10 from randomly performing a pumping operation by stopping the relative approach movement of the pair of the outer caps 40.

The cosmetic container 1 according to the present invention might comprise a head guide protrusion 90 protruded in a vertical, horizontal direction (Z-axis) of the pumping direction from the storing part head 23.

The head guide protrusion 90 according to the present invention is protruded in a direction of the lower, outer cap 43 from the storing part head 23.

At an inner surface of the lower, outer cap 43 is formed a head protrusion guide grove 95 guiding the movement of the head guide protrusion 90 in a pumping direction (X-axis direction) depending on the slide movement of the storing part 20.

The head protrusion guide groove 95 comprises a first head protrusion guide groove 96 guiding the head guide protrusion in the pumping direction (X-axis direction) depending on the slide movement of the storing part 20, and a second head protrusion guide groove 97 bent and extended from the first head protrusion guide groove 86 and guiding the head guide protrusion 90 in the rotation direction depending on the rotation movement of the storing part 20.

The first head protrusion guide groove 96 helps the storing part 20 to stably slide without shakes.

The second head protrusion guide groove 97 guides the rotation of the inner container 10, and stops the pumping operation of the storing part 20 when the inner container 10 rotates. Without an additional protection cap (not shown) as in the conventional art, it is possible to prevent the inner container from randomly pumping by preventing a relative approach movement of the pair of the outer caps 40.

In the preferred embodiment of the present invention, it was described that the slider 51 is provided at the inner container 10, and the guide groove 55 is formed at the guide number 53; however alternatively the slider 51 might be prepared at the guide member 53, and the guide groove 55 might be formed at the inner container 10.

In the preferred embodiment of the present invention, it was described that the locking protrusion 81 is provided at the inner cap 60, and the locking protrusion guide groove 83 is formed at the outer cap 40; however alternatively the locking protrusion 81 might be installed at the outer cap 40, and the locking protrusion guide groove 83 can be formed at the inner cap 60.

In the preferred embodiment of the present invention, it was described that the head guide protrusion 90 is provided at the inner container 10, and the head protrusion guide groove 95 is formed at the outer cap 40; however alternatively the head guide protrusion 90 is provided at the outer cap 40, and the head protrusion guide groove 95 is formed at the inner container 10.

The pumping operations of the cosmetic container 1 according to a preferred embodiment of the present invention will be described with reference to FIGS. 4 and 5.

FIGS. 4 and 5 are cross sectional views illustrating a pumping operation state of the cosmetic container 1 according to a preferred embodiment of the present invention.

As shown in FIG. 4, the user pressurizes the upper, outer cap 41 with the cosmetic container 1 being placed on a floor or pressurizes in a direction that the upper, outer cap 41 and the lower, outer cap 43 approach to each other with the cosmetic container 1 being held by the user's hands. Here, the pressurizing force of the user is enough to the extent that the elastic force of the elastic member 37 of the pumping part 30 can be overcome.

As shown in FIG. 5, when the elastic force of the elastic force is overcome, the moving force of the upper, outer cap 41 is transferred to the guide member 53, and when the guide member 53 moves downward, the slider 51 moves forward along the guide groove 55. As the slider 51 moves, the storing part 2 slides, thus performing a pumping operation.

The head guide protrusion 90 moves along the first head protrusion guide groove 96, thus helping the storing part 20 to smoothly slide without shakes.

When the user releases the pressurizing force from the outer cap 40, the elastic force of the elastic member 37 is recovered, and the storing part 20 moves backward. Here, the slider 51 pressurizes the guide groove 55, thus raising the guide member 53, so the pair of the outer caps 40 are spaced apart from each other.

The present invention is directed to a pumping structure by pressurizing the outer cap 40 as compared to the convention art in which the pumping head 31 is pressurized for pumping, so it is possible to easily change the outer appearance of the outer cap 40, which allows the design selections to be free, while making the outer appearance look better.

Here there is provided an intermediate cap 70 covering between the pair of the outer caps 40, thus preventing the inner structure to be exposed, which leads to a good looking appearance.

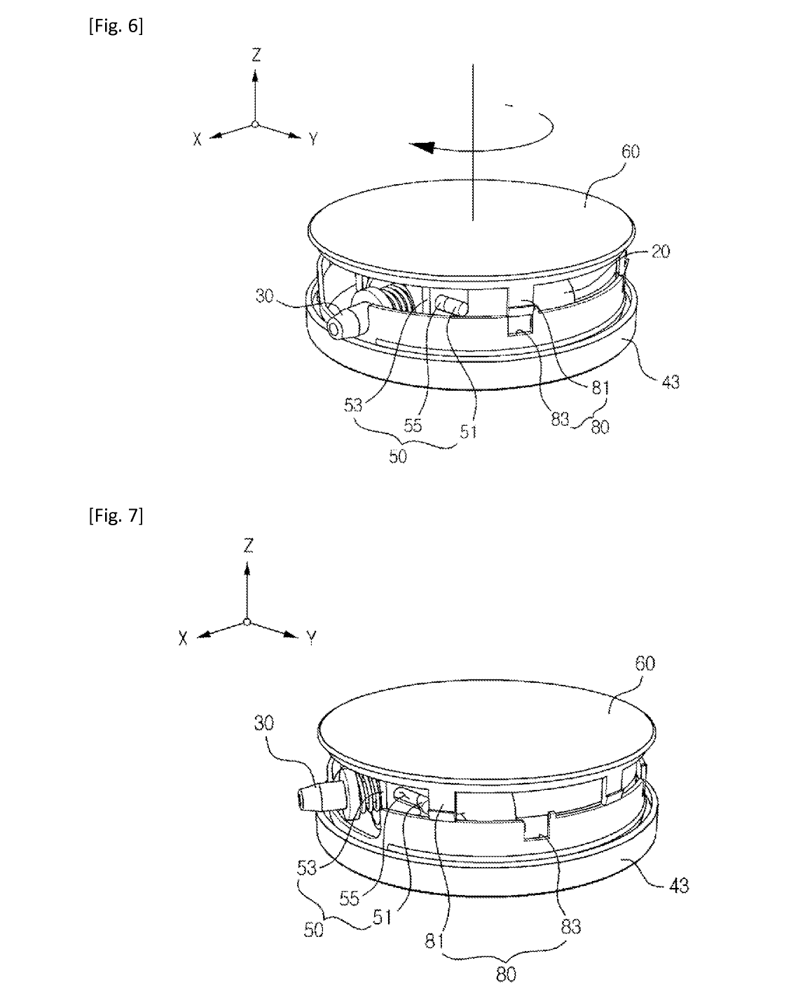

The locking operation of the cosmetic container 1 according to an embodiment of the present invention will be described with reference to FIGS. 6 and 7.

FIGS. 6 and 7 are perspective views illustrating an operation state of a locking part 80 of the cosmetic container 1 according to a preferred embodiment of the present invention.

As shown in FIG. 6, the cosmetic container 1 according to a preferred embodiment of the present invention is characterized in that the pair of the outer caps 40 are spaced apart from each other by means of the elastic force of the elastic member 37 of the pumping part 30 at usual time (when not pressurized by means of the user).

The locking protrusion 81 and the locking protrusion guide groove 83 are formed opposite to each other, so during the pumping operation, the locking protrusion 81 slides along the locking protrusion guide groove 83.

When the user rotates the upper, outer cap 41 and the lower, outer cap 43 in different directions, the upper, outer cap 41 relatively rotates for the lower, outer cap 43.

When the upper, outer cap 41 rotates, the inner cap 60 rotates with respect to the lower, outer cap 43. As shown in FIG. 7, the locking protrusion 81 and the locking protrusion guide groove 83 are dislocated, thus locking the pumping operation. As the locking protrusion 81 and the locking protrusion guide groove 83 are dislocated, even when the user pressurizes, the relative approach of the upper, outer cap 41 and the lower, outer cap 43 is stopped.

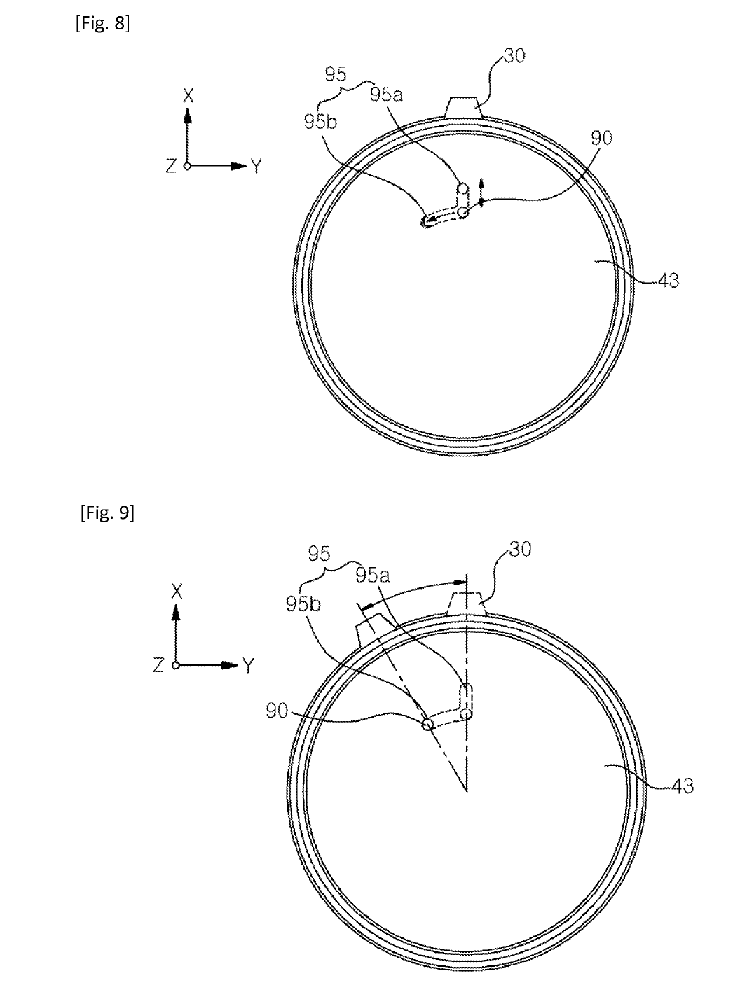

The clocking operation of the cosmetic container 1 will be described according to a preferred embodiment of the present invention with reference to FIGS. 8 and 9.

FIGS. 8 and 9 are bottom views illustrating a locking operation based on a movement state of a head guide protrusion 90 of a cosmetic container 1 according to a preferred embodiment of the present invention.

First, when the user rotates the upper, outer cap 41 and the lower, outer cap 43 in different directions, the upper, outer cap 41 rotates relatively for the lower outer cap 4.

When the upper, outer cap 41 rotates, the guide member 3 and the storing part 20 secured thereto rotate about the lower, outer cap 43. Here, the head guide protrusion 90 provided at the storing part head 23 of the storing part 20 rotates along the second head protrusion guide groove 97.

When the head guide protrusion 90 is accommodated in the second head protrusion guide groove 97, the storing part 20 does not move in the pumping direction. Even when the user pressurizes, the upper, outer cap 41 and the lower, outer cap 43 do not approach to each other, thus preventing a random pumping operation.

In the preferred embodiment of the present invention, the locking structure formed of the locking protrusion 81 and the locking protrusion guide grove 83 and the locking structure formed of the head guide protrusion 90 and the second head protrusion guide groove 97 are all adapted; however a manufacturer can select one between the above two structure.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A cosmetic container, comprising:
an inner container having a storing part storing a cosmetic, and a pumping part which relatively slides in a certain pumping direction (X-axis direction) and the storing part, thus discharging a cosmetic of the storing part to the outside;
a pair of outer caps which are disposed opposite to each other about the inner container in a vertical, horizontal direction (Z-axis direction) of the pumping direction; and
a conversion part which is disposed between the inner container and the outer cap and converts a relative approach movement of the pair of the outer caps into a relative slide movement of the storing part and the pumping part.

2. The container of claim 1, wherein said conversion part comprises:
a slider protruded from the storing part; and
a guide member which has a guide groove accommodating the slider and moving the slider in a pumping direction depending on a relative approach movement of the outer cap.

3. The container of claim 2, wherein said storing part comprises:
a storing part body having an opening, and a storing part head part formed at an opening of the storing part body, and the sliders are protruded in a pair opposite to each other in a horizontal direction (Y-axis direction) from the string part head.

4. The container of claim 3, wherein said guide groove is formed in a longitudinal hole shape with a certain slope.

5. The container of claim 4, further comprising:
a head guide protrusion which is protruded from the storing part head in a vertical, horizontal direction (Z-axis direction) of the pumping direction, with a head protrusion guide groove being formed at an inner surface of the outer cap in a pumping direction (X-axis direction) as the storing part slides, thus guiding the movement of the head guide protrusion.

6. The container of claim 5, wherein said head protrusion guide groove comprises:
a first head protrusion guide groove guiding a head guide protrusion in a pumping direction (X-axis direction) depending on the slide movement of the storing part; and
a second head protrusion guide groove which is bent and extended from the first head protrusion guide groove and guides the head guide protrusion in a rotation direction depending of the rotation of the storing part.

7. The container of claim 6, wherein said pumping part comprises:
a pumping head having a cosmetic discharge port;
a pumping hose connecting the cosmetic discharge port from the interior of the storing part; and
an elastic member disposed between the pumping head and the storing part head, thus providing an elastic force in a direction spacing apart from each other.

8. The container of claim 7, further comprising:
a ring shaped intermediate cap which has a through hole through which the cosmetic discharge portion passes, and covers between the pair of the outer caps.

9. The container of one among claims 1 through 8, further comprising:
an inner cap disposed between the outer cap and the inner container.

10. The container of claim 9, wherein said conversion part is disposed at the inner cap.

11. The container of claim 9, further comprising:
a locking part which is protrude and concaved at the portions corresponding to the inner cap and the outer cap which are dislocated depending on a relative rotation of the inner cap and the outer cap, thus prohibiting a relative approach movement of the pair of the outer caps.
